(19) United States
(12) Patent Application Publication
(10) Pub. No.: US 2014/0204418 A1
(43) Pub. Date: Jul. 24, 2014

(54) PRINT DATA GENERATING APPARATUS AND IMAGE RECORDING SYSTEM

(71) Applicant: OKI DATA CORPORATION, Tokyo (JP)

(72) Inventor: Satoshi YUMITA, Tokyo (JP)

(73) Assignee: OKI DATA CORPORATION, Tokyo (JP)

(21) Appl. No.: 14/178,558

(22) Filed: Feb. 12, 2014

Related U.S. Application Data
(62) Division of application No. 11/520,618, filed on Sep. 14, 2006, now abandoned.

(30) Foreign Application Priority Data
Sep. 29, 2005 (JP) 2005-285176

(51) Int. Cl. G06K 15/02

(52) U.S. Cl. CPC G06K 15/1893
USPC 358/1.15

(57) ABSTRACT

A print data generating apparatus includes a receiving unit for receiving first data sent from an application; a selection unit for selecting second data stored in a storage unit of a terminal device; an insertion page information generating unit for assigning a page where the second data are inserted into the first data created by the application; a blank page addition unit for generating third data in which a blank page is added to the page of the first data assigned by the insertion page information generating unit; a direction unit for directing the terminal device to overlay the second data on the blank page; and a print data generating unit for generating print data according to the third data and the direction of the direction unit.

### CROSS-REFERENCE TO RELATED APPLICATIONS

This is a divisional application of a prior application Ser. No. 11/520,618, filed Sep. 14, 2006, pending.

### BACKGROUND OF THE INVENTION AND RELATED ART STATEMENT

The present invention relates to a print data generating apparatus using an overlay printing unit and a duplex printing unit. Further, the present invention relates to an image recording system including the print data generating apparatus.

In a printer having a form overlay printing function, a hard disk is disposed inside the printer for registering a ledger sheet or a logo as a form. In the form overlay printing, other print data are printed over the form (see Patent Reference).

For example, on a medical record form, a prescription, or a direct mail, a front side thereof is printed with contents different per page, and a backside thereof is printed with a standard format such as direction or information. When a conventional printer prints such a form, first, the printer prints on the backside of the form using the form overlay printing function, and then prints on the front side thereof.

Alternatively, in a printer having the form overlay printing function and a duplex printing unit, an upper device forms a standard format of a backside on even pages with an application program (application), so that the form is printed through the duplex printing.
Patent Reference: Japanese Patent Publication No. 09-9043

In the conventional printer without the duplex printing unit, it is necessary to reset a sheet in a tray such that a front side thereof becomes a printing side to be printed after a backside thereof is printed through one-side printing, thereby causing cumbersome problem. In the conventional printer with the duplex printing unit, when print data of the backside are changed, it is necessary to change all of data of even pages, i.e., the backsides, even though all of data are the same, thereby causing another cumbersome problem.

In view of the problems described above, an object of the present invention is to provide a print data generating apparatus capable of solving the problems described above.

Further objects and advantages of the invention will be apparent from the following description of the invention.

### SUMMARY OF THE INVENTION

In order to attain the objects described above, according to the present invention, a print data generating apparatus comprises a receiving unit for receiving first data sent from an application; a selection unit for selecting second data stored in a storage unit of a terminal device; an insertion page information generating unit for assigning a page where the second data are inserted into the first data created by the application; a blank page addition unit for generating third data in which a blank page is added to the page of the first data assigned by the insertion page information generating unit; a direction unit for directing the terminal device to overlay the second data on the blank page; and a print data generating unit for generating print data according to the third data and the direction of the direction unit.

With the configuration described above, the data created with the application are used as the print data for one side, and the form data registered in advance are used to create the print data for the other side, so that the print data are printed with the overlay printing unit. Accordingly, it is not necessary to reset a sheet in a tray such that a front side thereof becomes a printing side to be printed after a backside thereof is printed through one-side printing. Further, it is not necessary to change all of pages of the form data.

### BRIEF DESCRIPTION OF THE DRAWINGS

FIG. 1 is a block diagram showing a printer driver according to a first embodiment of the present invention;

FIG. 2 is a flow chart showing a process of registering a form according to the first embodiment of the present invention;

FIG. 3 is a flow chart showing a process of overlay printing according to the first embodiment of the present invention;

FIG. 4 is a view showing an example of a screen showing an overlay setting dialog according to the first embodiment of the present invention;

FIG. 5 is a view showing another example of a screen showing an overlay setting dialog according to the first embodiment of the present invention;

FIG. 6 is a view showing an example of a screen showing a departure dialog according to the first embodiment of the present invention;

FIG. 7 is a view showing an example of a screen showing an overlay definition dialog according to the first embodiment of the present invention;

FIG. 8 is a view showing an example of a screen showing an overlay dialog according to the first embodiment of the present invention;

FIG. 9 is a flow chart showing a process of backside overlay printing according to the first embodiment of the present invention;

FIG. 10 is a flow chart showing a process of overlay processing according to the first embodiment of the present invention;

FIGS. 11(a) to 11(d) are views showing examples of data and a printed result according to the first embodiment of the present invention;

FIG. 12 is a block diagram showing a process block according to a second embodiment of the present invention;

FIG. 13 is a block diagram showing a printer processor and a surrounding thereof according to the second embodiment of the present invention;

FIG. 14 is a flow chart showing a process of print data generation according to the second embodiment of the present invention;

FIG. 15 is a flow chart showing a process of a printer processor according to the second embodiment of the present invention;

FIGS. 16(a) to 16(d) are views showing examples of data and a printed result according to the second embodiment of the present invention;

FIG. 17 is a block diagram showing a printer driver according to a third embodiment of the present invention;

FIG. 18 is a flow chart showing a process of backside overlay printing according to the third embodiment of the present invention; and

FIGS. 19(a) to 19(c) are views showing examples of data and a printed result according to the third embodiment of the present invention.

### DETAILED DESCRIPTION OF PREFERRED EMBODIMENTS

Hereunder, embodiments of the present invention will be explained with reference to the accompanying drawings.

### First Embodiment

In a first embodiment, a print data generating apparatus uses data created with an application as print data for a front side, and generates print data using form data registered in advance as common print data for a backside, so that the print data is printed with an overlay printing unit.

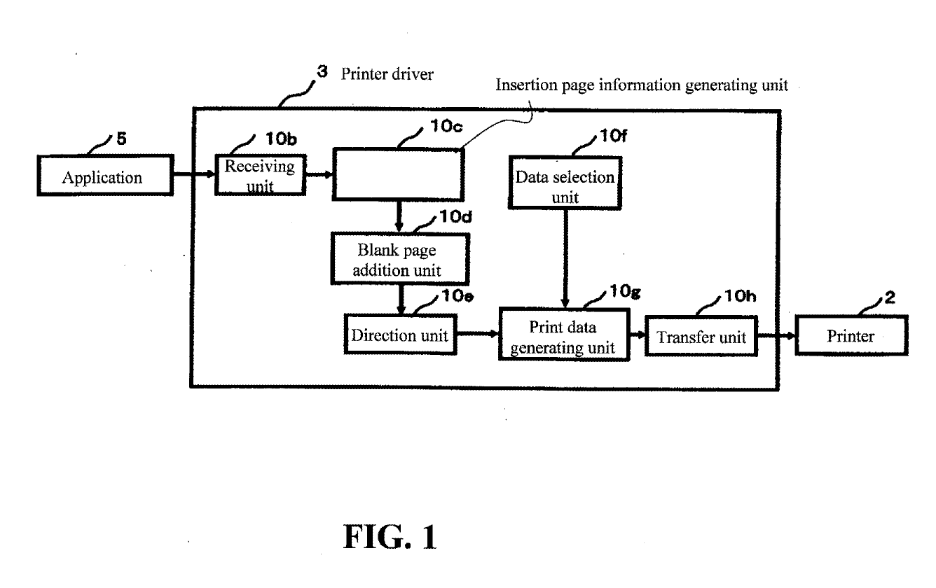

FIG. 1 is a block diagram showing a printer driver 3 according to the first embodiment of the present invention. As shown in FIG. 1, the printer driver 3 includes a receiving unit 10b for receiving data (first data) created with an application 5 such as a document creation program and a drawing program; an insertion page information generating unit 10c for assigning a page of the data where the form data is inserted; a blank page addition unit 10d for generating a blank page on a page corresponding to the page where the form data is inserted; a direction unit 10e for directing to overlay the form data selected at a data selection unit 10f (described later) on the blank page, or directing to perform duplex printing in a backside (or front side) overlay mode; the data selection unit 10f for selecting the form data to be overlaid and assigning an ID thereof; a print data generating unit 10g for converting to PDL that a printer 2 can interpret; and a transfer unit 10h for sending the print data to the printer 2.

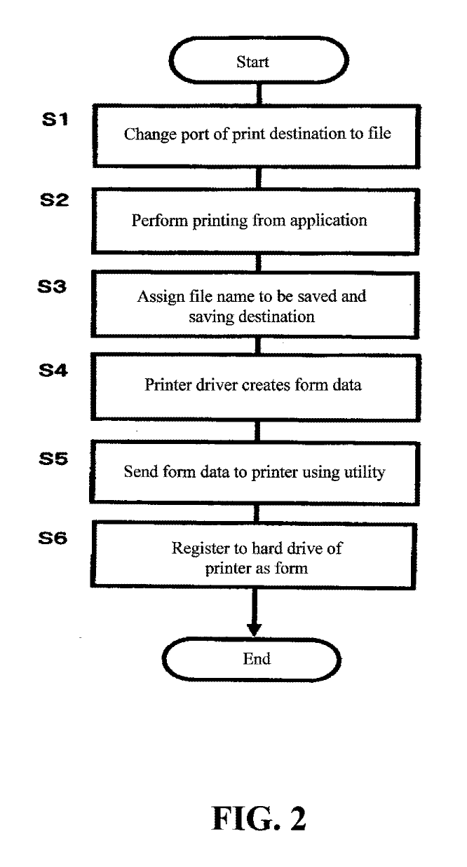

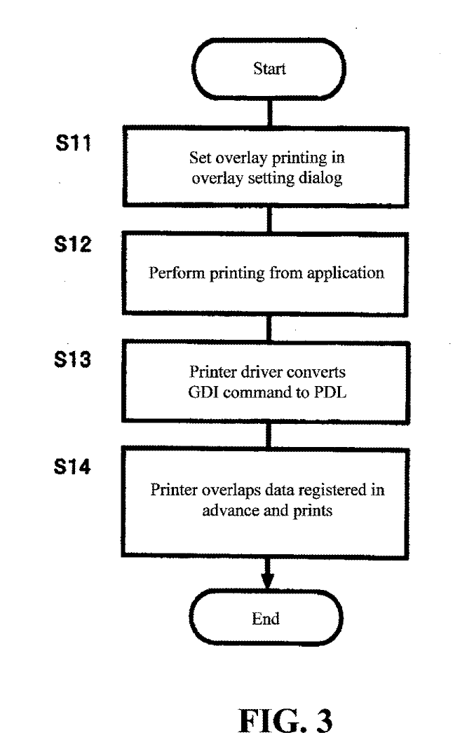

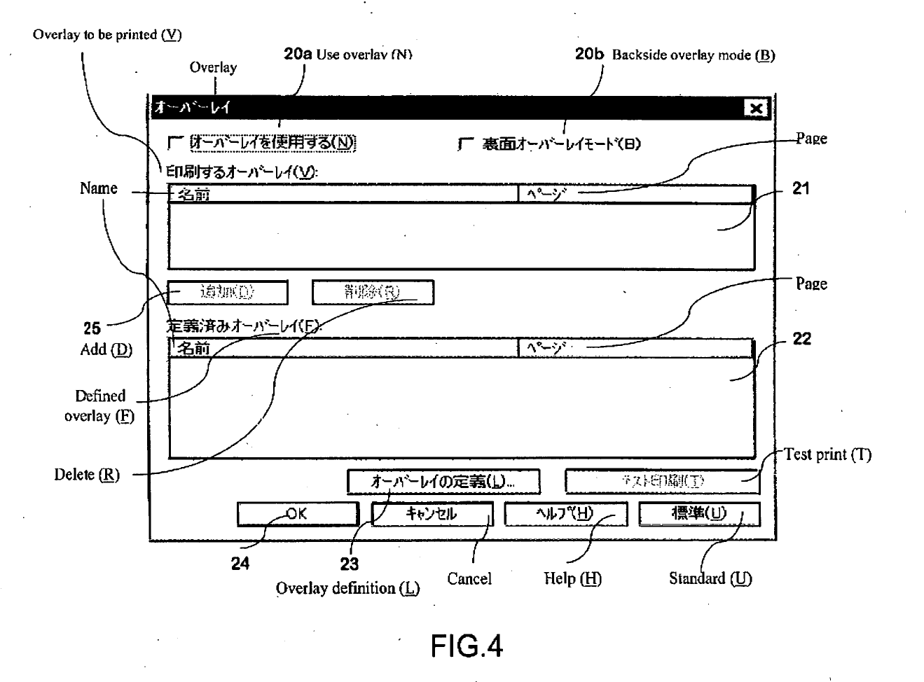

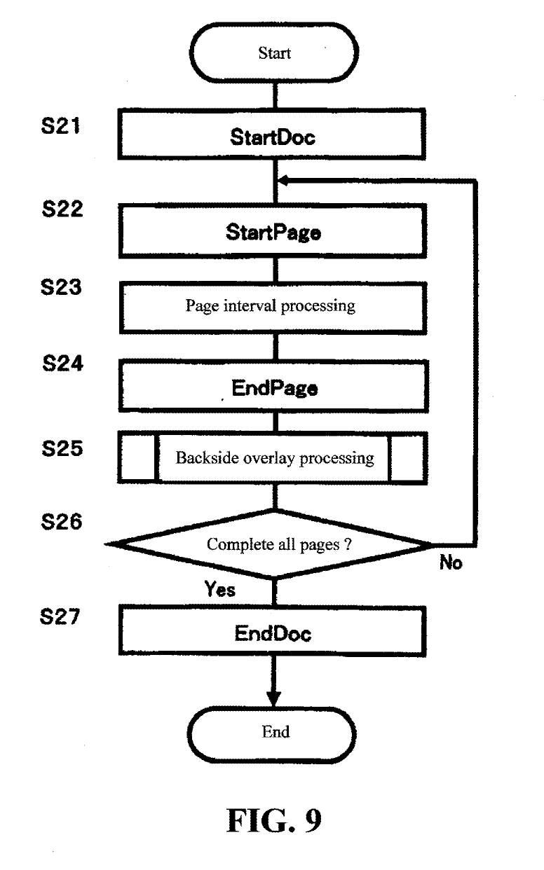

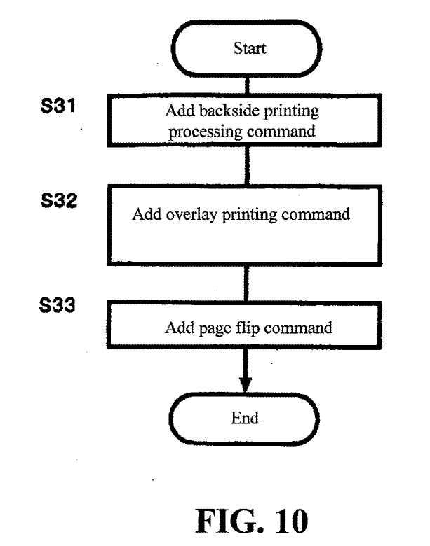

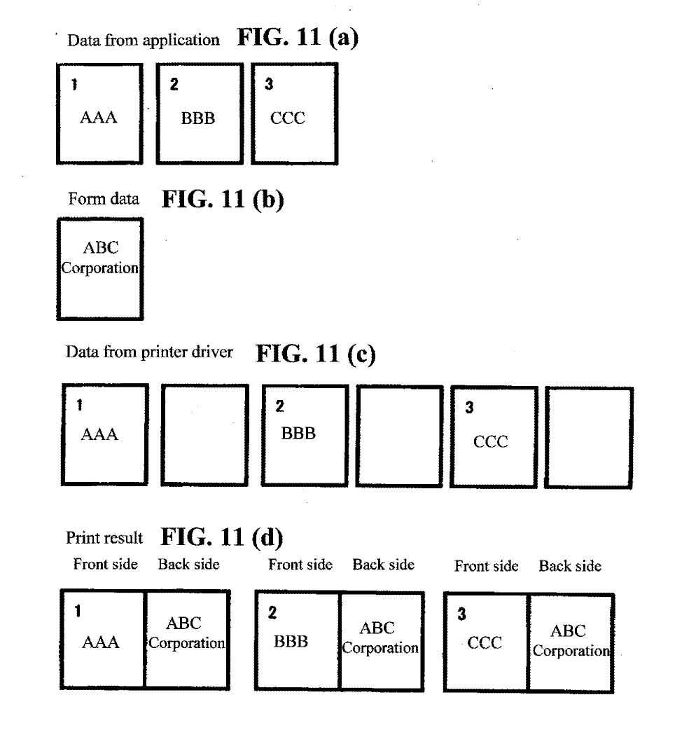

An operation of the print data generating apparatus will be explained next. FIG. 2 is a flow chart showing a process of registering a form according to the first embodiment of the present invention. FIG. 3 is a flow chart showing a process of overlay printing according to the first embodiment of the present invention. FIGS. 4 to 8 are views showing examples of various dialogs according to the first embodiment of the present invention. FIG. 9 is a flow chart showing a process of backside overlay printing according to the first embodiment of the present invention. FIG. 10 is a flow chart showing a process of overlay processing according to the first embodiment of the present invention. FIGS. 11(a) to 11(d) are views showing examples of data and a printed result according to the first embodiment of the present invention

FIG. 11(a) is a view showing data created with the application 5 and contents to be printed on the front side. As shown in FIG. 11(a), in the embodiment, “1 AAA” is the contents to be printed on a front side of the first page; “2 BBB” is the contents to be printed on a front side of the second page; and “3 CCC” is the contents to be printed on a front side of the third page. FIG. 11(b) is a view showing the form data to be printed on the backside. As shown in FIG. 11(b), “ABC Corporation” is the contents to be printed on the backsides of the first to third pages. FIG. 11(c) is a view showing print data created with the printer driver 3. As shown in FIG. 11(c), the contents to be printed on the front side shown in FIG. 11(a) are printed on odd number pages, and blank data are printed on even number pages. FIG. 11(d) is a view showing a final printed result.

With reference to FIG. 2, the process of registering the form to the printer will be explained next. In step S1, an operator changes a port of a printer to a file. In step S2, the print data to be registered as the form are printed from the application. In step S3, the operator assigns, for example, a desktop computer and a temporary folder as a file name to be saved and a saving destination.

In step S4, the print data from the application 5 are described with the GDI (Graphical Device Interface) graphic command of Windows (trademark of Microsoft). The printer driver 3 converts the GDI graphic command to PDL (Page Description Language) that the printer can interpret, so that the print data to be the form data are created as a file.

In step S5, using storage device manager, i.e., one of utilities or an application for administering a hard drive of the printer 2, the file created in step S4 is sent to the printer 2. At this time, the storage device manager adds a command of registering the file to the printer 2 to the data created in step S4.

In step S6, the printer 2 stores the data received from the storage device manager in the hard drive of the printer 2, so that the form data shown in FIG. 11(b) are registered as the form data.

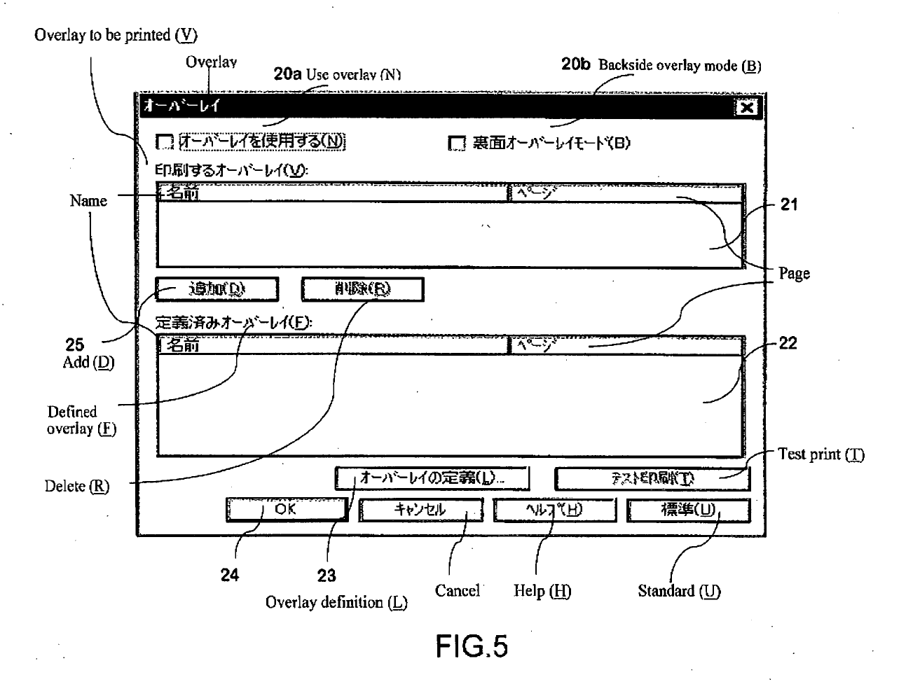

With reference to FIGS. 4 and 5, a dialog to be displayed in the operation of defining overlay will be explained next. FIGS. 4 and 5 are views showing examples of an overlay dialog to be displayed when printer property of a print dialog is selected. As shown in FIGS. 4 and 5, in the dialog, a check box 20a of usage of the overlay and a check box 20b of backside overlay are arranged at an upper portion thereof; an overlay list 21 is arranged at a position below the upper portion; and an overlay list after being defined is arranged at a lower portion thereof.

When the printer is not provided with the duplex printing unit, since the printer does not perform the duplex printing, the check box 20b of backside overlay is ghosted, so that the backside overlay cannot be selected.

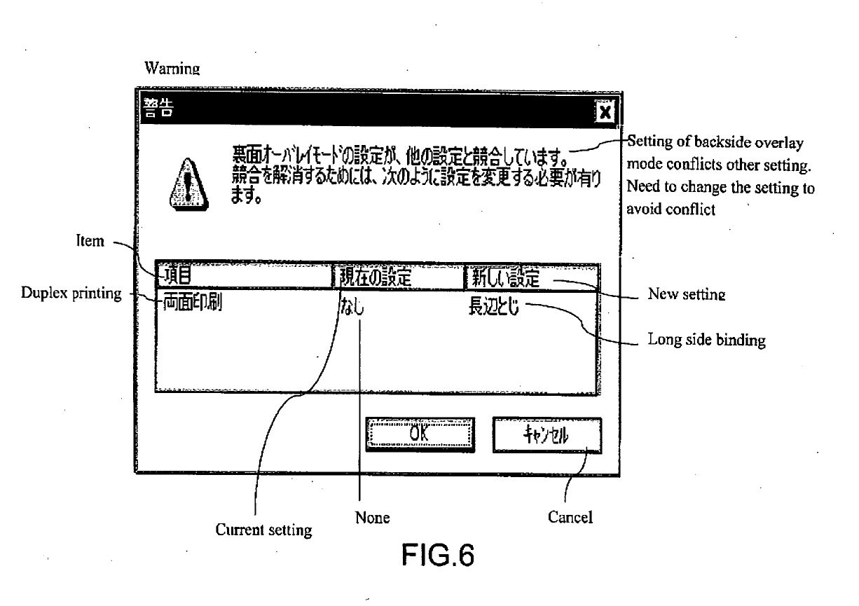

FIG. 6 is a view showing an example of a screen showing a departure dialog to be displayed when the backside overlay is selected from the normal printing state. It is arranged such that the setting can be changed to perform the duplex printing after the dialog is displayed. When the backside overlay is selected, the check box 20a of usage of the overlay is ghosted, so that the operator cannot deactivate the overlay function.

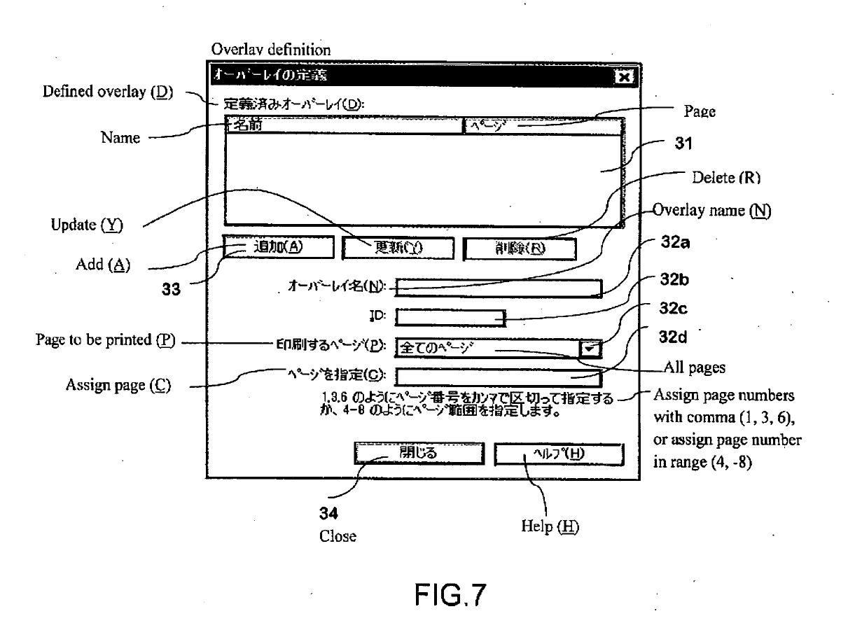

FIG. 7 is a view showing an example of a screen showing a dialog for performing an operation such as a setting, adding, or deleting a definition of the overlay. In the dialog shown in FIG. 7, there are arranged an input box 32a for inputting an arbitrary overlay name; an input box 32b for inputting a macro ID of the form registered to the printer with the storage device manager; and page assigning boxes 32c and 32d for assigning a page to be printed.

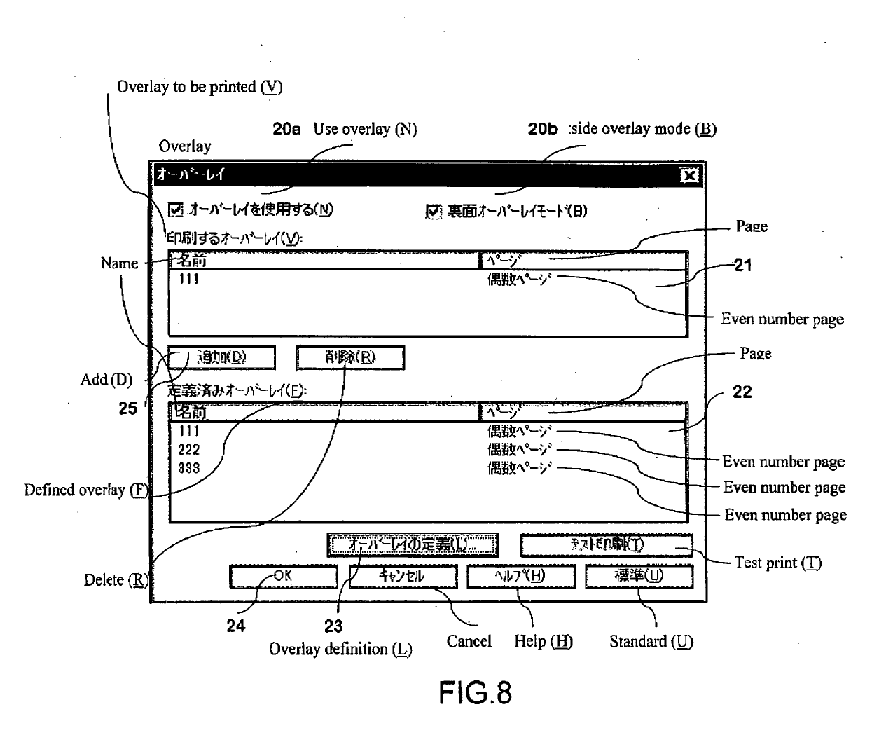

FIG. 8 is a view showing a dialog for displaying a state that the definition of the overlay is displayed, and for performing an operation such as verifying, changing, adding, or deleting the definition of the overlay.

An operation of defining the overlay will be explained next. First, in the overlay dialog shown in FIG. 4 in the default state to be displayed when the printer property is selected, an overlay definition button 23 is pushed, thereby displaying the overlay definition dialog shown in FIG. 7. In the dialog, the operation such as verifying, changing, adding, or deleting the definition of the overlay is performed.

After desired contents are input in the boxes, when an addition button 33 is pushed, the form data is registered to the printer driver 3 as the defined overlay, and is displayed in a defined overlay list box 22 shown in FIG. 8.

After the setting of the definition of the overlay is completed, when a close button 34 is pushed, the overlay dialog shown in FIG. 8 is returned. At this time, the contents registered in a defined overlay list box 31 in the overlay definition dialog shown in FIG. 7 are displayed in the defined overlay list box 22 in the overlay dialog shown in FIG. 8.

Then, the overlay to be used is selected from the list box 22, and an addition button 25 is pushed, so that the overlay is added to the overlay list box 21 arranged at the upper portion. When an OK button 24 is clicked, the overlay dialog is closed, and the printer property setting screen is returned.

As described above, the added overlay is printed as the overlay upon printing. When the backside overlay mode 20b is checked as shown in FIG. 8, the overlay is printed as the backside overlay (described later).

In a standard format, a common portion (form) such as a ledger sheet is separated from a non-common portion (non-form) such as a personal name or address to be filled in the form. Then, the macro function, i.e., a function for replacing a plurality of commands and data to a printer with one single command, is used to register each form to the printer corresponding to a macro ID, i.e., a number assigned to the macro. When the non-form is printed, the desired macro ID is selected, so that the form and the non-form are printed through the overlay printing.

With reference to the flow chart shown in FIG. 3, the operation of the overlay printing will be explained next. In step S11, the operator creates document data with the application 5, and sets the overlay printing in the overlay setting dialog shown in FIG. 4. In step S12, the printing is started with the application 5, and the printer driver 3 converts the GDI graphic command to PDL.

In step S13, the macro ID corresponding to the form created in the overlay setting dialog is added to the selected command, so that the print data is created. In step S14, the data created with the printer driver 3 and the form data registered in the printer 2 in advance are printed in the overlaid state, so that the document data is overlaid on the designated form.

With reference to FIGS. 9 and 10, the process of the printer driver when the backside overlay mode is selected will be explained next.

In step S21, when a print button in a print dialog (not shown) is clicked to start the printing, the printer driver 3 calls for “StartDoc” from GDI, so that the print job is started. In step S22, “StartPage” is called to start a page. In step S23, after “StartPage” is called, data in the page described with the GDI graphic command is converted to PDL. In step S24, after one page is processed, “EndPage” is called. In step S25, the backside overlay (described later) is performed, thereby completing the process of one page.

In step S26, it is determined whether all pages are printed. When there is no next page, in step S27, “EndDoc” is called, thereby completing the print job. When there is a next page, the process returns to step S22, thereby processing the next page.

With reference to the flow chart shown in FIG. 10, the process of the backside overlay in step S25 shown in FIG. 9 will be explained in more detail.

In step S31, the printer driver 3 adds the command for selecting the backside printing in the “EndPage” process (page completion process), so that the duplex printing unit prints on the backside. In step S32, the printer driver 3 adds the command for calling for the macro ID corresponding to the overlay to be printed set in the overlay dialog in the printer property shown in FIG. 8. In step S33, the printer driver 3 adds a page flip command for creating the blank page after each page, thereby competing the backside overlay process.

As described above, in the overlay printing process, the form and the non-form are printed in the overlaid state. In the backside overlay process, when the form is printed, the backside print command and the page flip command are added. Accordingly, the non-form, i.e., the data created with the application 5, is printed on the front side, and the form is printed on the backside.

As a result, according to the data created with the application 5 shown in FIG. 11(a), the blank page is inserted to the page where the form is printed as shown in FIG. 11(a). Then, with the overlay function, the form data shown in FIG. 11(b) is overlaid on the blank page, thereby obtaining the print result shown in FIG. 11(d).

In the first embodiment, the data created with the application 5 are printed on the front side, and the form data are printed on the backside through the backside overlay printing. Alternatively, the command for calling for the Macro ID and the page flip command may be added before each page created with the application. Accordingly, it is possible to print the form data on the front side and the data created with the application 5 on the backside.

Further, the command for calling for the Macro ID and the page flip command may be added at the last portion of data of a previous page of a desired page. Accordingly, it is possible to overlay the form data only on the desired page.

As described above, in the print data generating apparatus according to the first embodiment, the data created with the application is used as the print data for the front side. The common print data for the backside is created using the form data registered in advance. The front side and backside are printed with the overlay printing unit. Accordingly, it is not necessary to reset a sheet in a tray such that the front side thereof becomes the printing side to be printed after the backside is printed. Further, it is not necessary to change all of pages of the form data.

### Second Embodiment

A second embodiment of the present invention will be explained next. In a print data generating apparatus according to the second embodiment, data of the first page created with the application is used as data of the backside. The printer driver is set to the duplex printing mode, so that the data of the first page are printed on the backside of each page with the printer driver.

First, terminology associated with the print data generating apparatus according to the second embodiment will be explained. In general, a spool format upon printing, i.e., a format for saving data to be sent to a printer as a file in a disk, includes RAW and EMF. RAW (raw data) is a specific format dependent on a language system of a printer. EMF (Enhanced Metafiles Format) is a format using the GDI (Graphical Device Interface) graphic command of Windows (trademark of Microsoft). A file created with EMF is called an EMF file.

The GDI graphic command stored as the EMF file is delivered to the printer driver with a spooler, i.e., one of functions of OS administering a plurality of job commands. Then, the GDI graphic command is converted to PDL and delivered to the printer 2, thereby printing.

Next, a “print processor” will be explained. The print processor sends the spool data to the printer as is when the spool format is RAW, and regenerates or de-spools the EMF file when the spool format is EMF. When the print processor regenerates the EMF file, depending on the method of regeneration, it is possible to perform editing and processing the print data such as enlarging, reducing, rotating, and repeating printing. As described later, in the print data generating apparatus according to the second embodiment, the print processor performs editing according to a print order.

Next, a “Devmode structure” will be explained. The Devmode structure is a collection of variables defined by GDI. For example, the Devmode structure includes information such as a sheet size and resolution necessary for printing. As described later, in the print data generating apparatus according to the second embodiment, the backside overlay is set in the printer property of the printer driver 3, so that a variable related to the overlay in an extension portion of the Devmode structure is changed from 0 to 1. Accordingly, the backside overlay is set for performing the backside overlay printing.

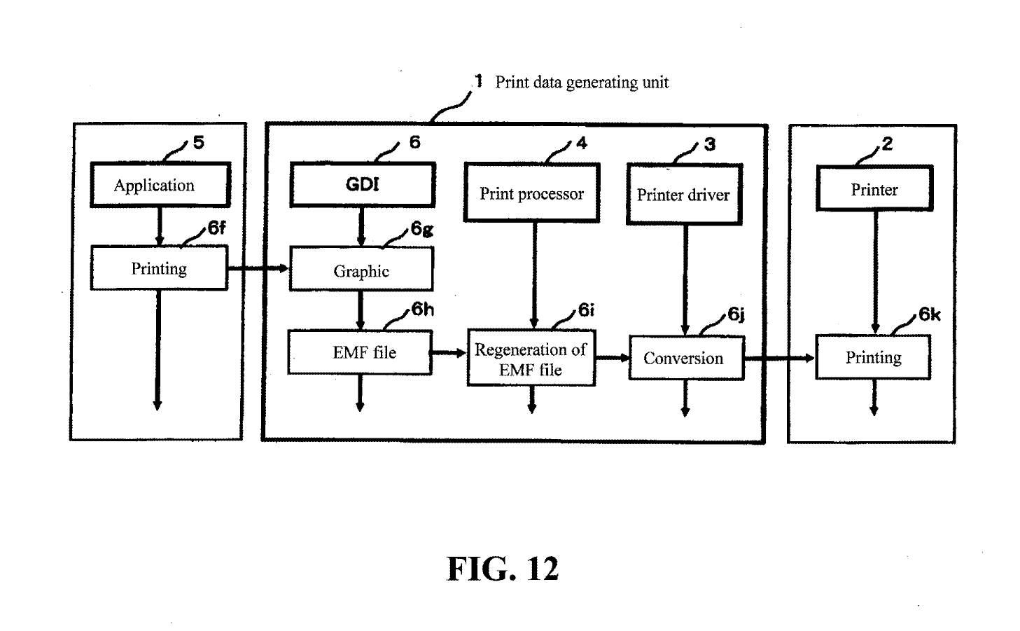

FIG. 12 is a block diagram showing a process block when the spool format is EMF. As shown in FIG. 12, according to the second embodiment, the print data generating apparatus 1 includes GDI 6, the print processor 4, and the printer driver 3. According to the data from the application 5, each unit of the print data generating apparatus 1 creates the print data, and the print data are sent to the printer 2 for printing. More specifically, the application 5 performs a print start process 6f, and GDI 6 performs a graphic process 6g and an EMF file process 6j, so that the EMF file as the page data is created. Further, the print processor 4 performs an EMF file regeneration process 6i; the printer driver 3 performs a conversion process 6j; and the printer 2 performs a printing process 6k.

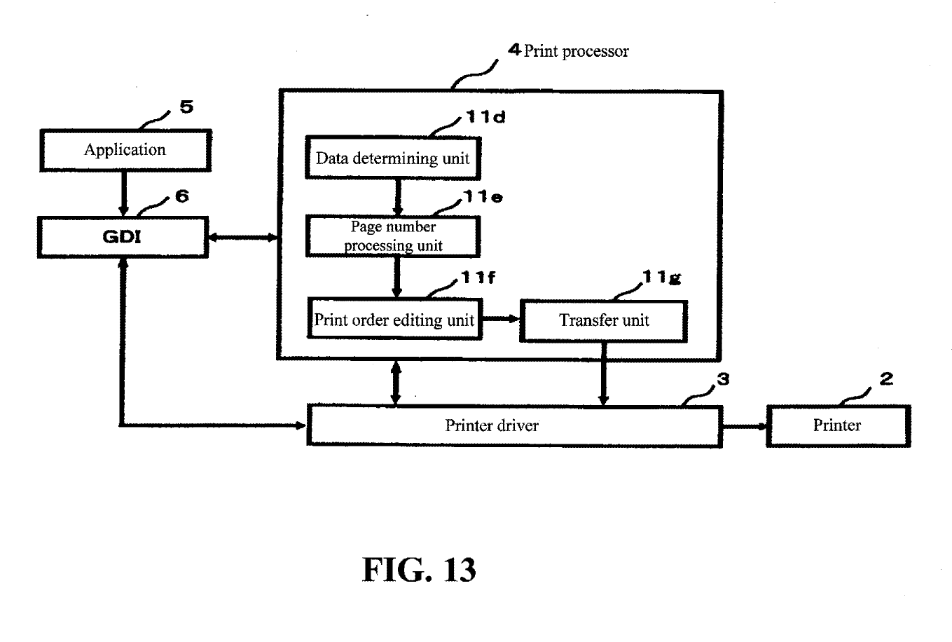

FIG. 13 is a block diagram showing the printer processor 4 and a surrounding thereof according to the second embodiment of the present invention. As shown in FIG. 13, the printer processor 4 includes a data determining unit 11d for determining whether the overlay or the normal printing is set at the printer driver 3; a page number processing unit 11e for obtaining a total number of pages of the data of the application 5 to calculate pages to be printed, and for determining whether the pages to be printed are the pages in which the first page is to be regenerated or the pages of a=a+1 are to be regenerated; a print order editing unit 11f for editing an order in which EMF of the first page of the a=a+1 page is regenerated according to the result of the pages to be printed at the page number processing unit 11e; and a transfer unit 11g for sending EMF to the printer driver in the order edited at the print order editing unit 11f.

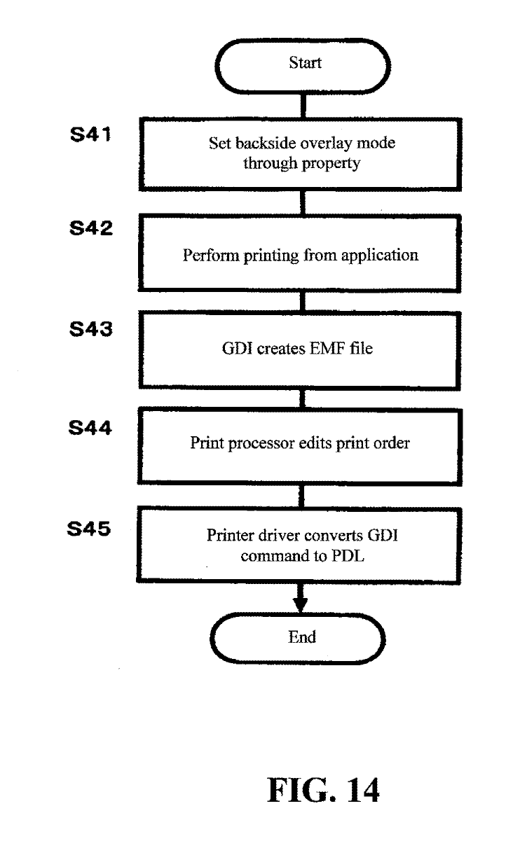

As shown in FIG. 14, the print processor 4 is connected to the printer driver 3 and GDI 6.

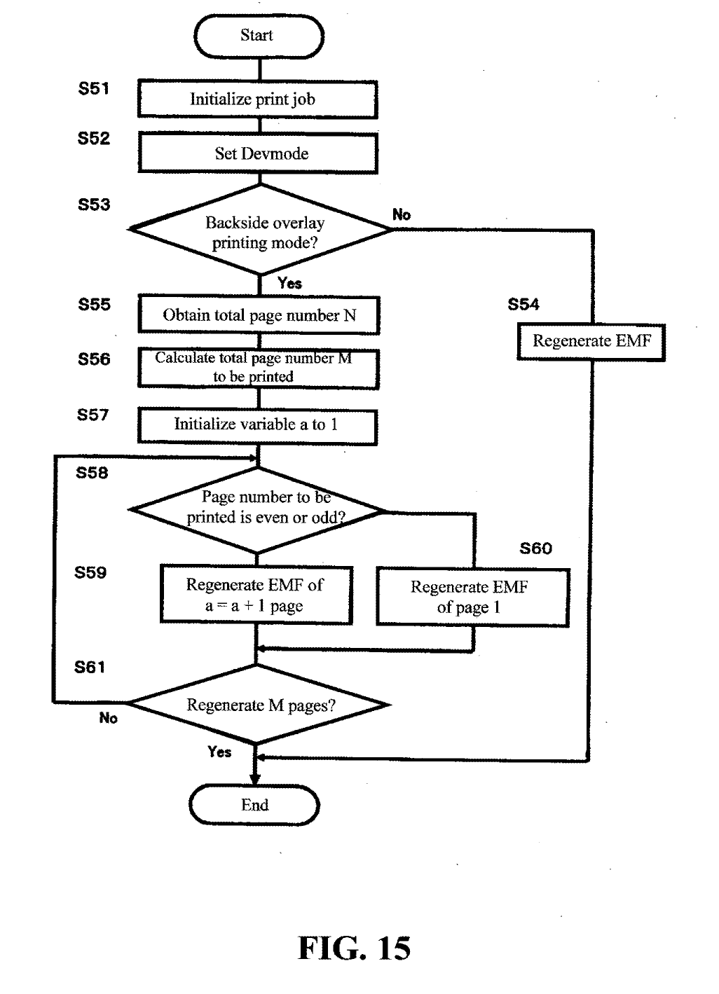

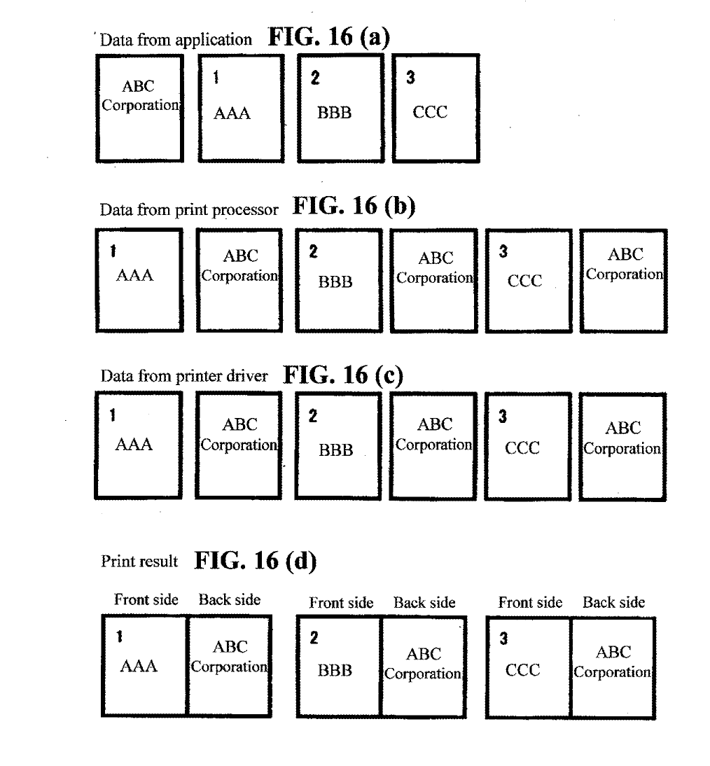

An operation of the printer processor 4 according to the second embodiment will be explained next with reference to FIGS. 12, 14, 15, and 16(a)-16(d). FIG. 14 is a flow chart showing a process of print data generation according to the second embodiment of the present invention. FIG. 15 is a flow chart showing a process of the printer processor according to the second embodiment of the present invention. FIGS. 16(a) to 16(d) are views showing examples of generated data and a printed result in each step.

FIG. 16(a) is a view showing data created with the application 5. In the embodiment, contents to be printed on the backside in common are created on the first page; contents to be printed on the front side of the first page are created on the second page; contents to be printed on the front side of the second page is created on the third page; and contents to be printed on the front side of the third page are created on the fourth page.

FIG. 16(b) is a view showing a result in which the print processor 4 arranges the contents to be printed on the front side in odd number pages in order, and the contents to be printed on the backside in common in even number pages. FIG. 16(c) is a view showing a result in which the printer driver 3 converts the result of the pages edited at the printer processor 4 to PDL. Accordingly, FIGS. 16(b) and 16(c) show the same view. FIG. 16(d) is a view showing a result printed with the printer 2 based on the print data converted to PDL.

With reference to FIGS. 12 and 14, a printing operation will be explained next. First, the operator uses the application 5 to create the form data to be printed on the backside in common on the first page as the first data, and the contents to be printed such as texts and graphics on the second and subsequent pages.

In step S41, the operator sets the backside overlay mode through the printer property. In step S42, the print start process 6f is directed to start. In step S43, GDI 6 uses the GDI graphic command to create the graphics (graphic process 6g). the EMF file as the page data storing the GDI graphic record is created (EMF file process 6h).

After the EMF file is created, in step S44, the EMF file is delivered to the print processor 4 to regenerate the EMF file and edits the print order (EMF file regeneration process 6i). In step S45, the printer driver 3 converts the graphic contents regenerated in the EMF file regeneration process 6i to PDL (conversion process 6j). The converted data is sent to the printer 2 for printing (printing process 6k).

With reference to the flow chart shown in FIG. 15, the editing operation of the print order in the print processor 4 will be explained next. In step S51, the print processor 4 called by the GDI 6 initializes the print job. In step S52, the Devmode structure is set and referred to. In step S53, it is determined whether the printing setting is the backside overlay printing mode according to the Devmode structure. In step S54, when the printing setting is the normal mode, not the backside overlay printing mode, EMF is regenerated in the page order, thereby completing the process.

When it is determined that the printing setting is the backside overlay printing mode in step S53, in step S55, the total printed page number N is obtained with the application 5. In step S56, since the actual page number to be printed is 2N, the total page number M to be printed is assigned as 2N.

In step S57, the variable a to be used as the page number of the application 5 is initialized to 1. In step S58, it is determined whether the page to be printed is the even number page or the odd number page. In step S59, when the page to be printed is the odd number page, EMF of a=a+1 page is regenerated. In step S60, when the page to be printed is the even number page, EMF of the first page is regenerated. In step S61, the process is repeated until the total pages (M) are regenerated.

As described above, in the second embodiment, the print processor 4 edits the print order. Accordingly, the GDI command is delivered to the printer driver 3 in the order of the data of the second page, the data of the first page, the data of the third page, the data of the first page, the data of the fourth page, and the data of the first page shown in FIG. 16(a). When the command for setting the one-side printing or the duplex printing is sent, the printer driver 3 sends the command for setting the duplex printing, so that the duplex printing is performed in the StartPage process (page start process). In other processes, similar to the normal printing, the GDI command is converted to PDL, thereby creating the print data.

Through the operation of the print data generating apparatus according to the second embodiment, as shown in FIG. 16(b), the print processor 4 edits the print data shown in FIG. 16(a) and created with the application. As shown in FIG. 16(c), the printer driver 3 converts the print data to PDL, and the printer 2 prints as shown in FIG. 16(d).

In the second embodiment, the backside overlay printing is performed for printing the form data on the backside. The invention is not limited thereto. Alternatively, the EMF regeneration process of the first page in step S60 in FIG. 15 may be performed when the page to be printed is the odd number page; and the EMF regeneration process of the a=a+1 page in step S59 may be performed when the page to be printed is the even number page. Accordingly, it is possible to print the form data on the odd number pages and any contents on the backside thereof.

When the operator wants to print the form data on a specific page, for example, the third page, the EMF regeneration process of the first page in step S60 is performed when the page to be printed is the third page. Accordingly, it is possible to print the form data on the specific page. When the form data is printed on the specific page, the total page number M to be printed becomes a sum of the total page number N printed with the application and the specified page number.

In the second embodiment, the first page created with the application 5 is used as the form data. Alternatively, print contents of a specific page may be set as the form data, so that the form data are printed on the backside or the specific page.

As described above, in the print data generating apparatus according to the second embodiment, the application creates the print data as the normal print data, and the print processor treats the data of the first page as the data of the even number pages. Accordingly, with the simple operation, it is possible to print different contents per page on the front side and the form data on the backside. Further, it is not necessary to register the form to the printer 2, thereby making it not necessary to provide a storage unit for registering the form.

### Third Embodiment

A third embodiment of the present invention will be explained next. In a print data generating apparatus according to the third embodiment, the data of the first page created with the application upon printing are registered to the printer as the form data. The duplex printing mode is set with the printer driver. The data of the first page, i.e., the form data, are used relative to the data of the second and subsequent pages for printing the backside.

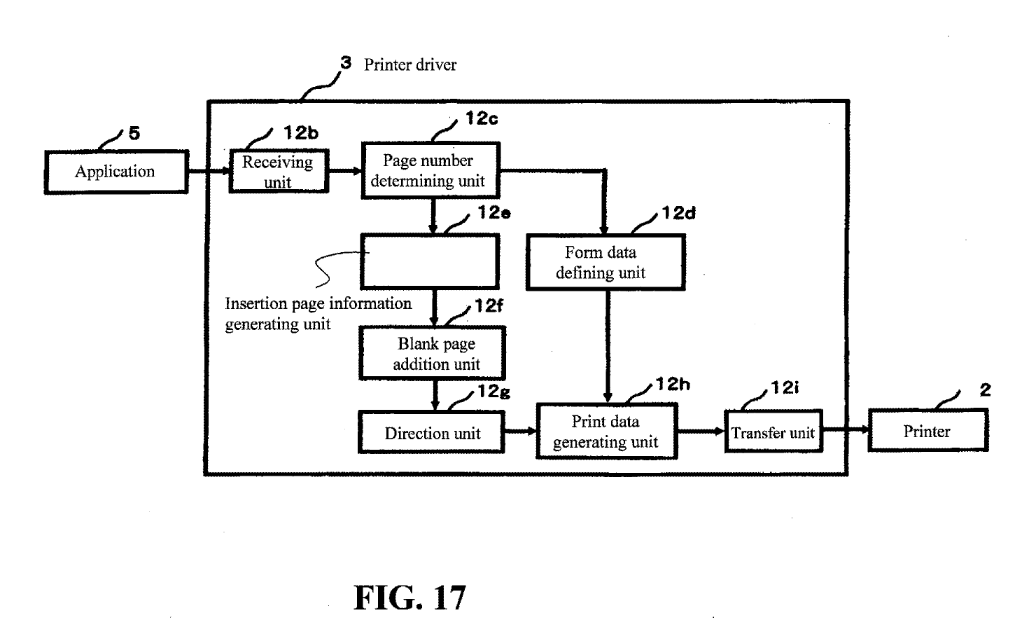

FIG. 17 is a block diagram showing the printer driver 3 of the print data generating apparatus and a surrounding configuration thereof according to the third embodiment of the present invention.

As shown in FIG. 17, the printer driver 3 includes a receiving unit 12b for receiving the data created with the application 5; a page number determining unit 12c for determining whether the data are for the first page or the second page; a form data defining unit 12d for defining the data of the first page as the form data and adding an ID; an insertion page information generating unit 12e for assigning a page among the second and subsequent pages where the form data are inserted; a blank page addition unit 12f for generating a blank page on the page defined with the insertion page information generating unit 12e where the form data are inserted; a direction unit 12g for directing the duplex printing when the form data defined at the form data defining unit 12d are set to be printed in the backside overlay mode (or front side overlay mode); a print data generating unit 12h for converting to PDL that the printer can interpret; and a transfer unit 12i for sending the print data to the printer 2.

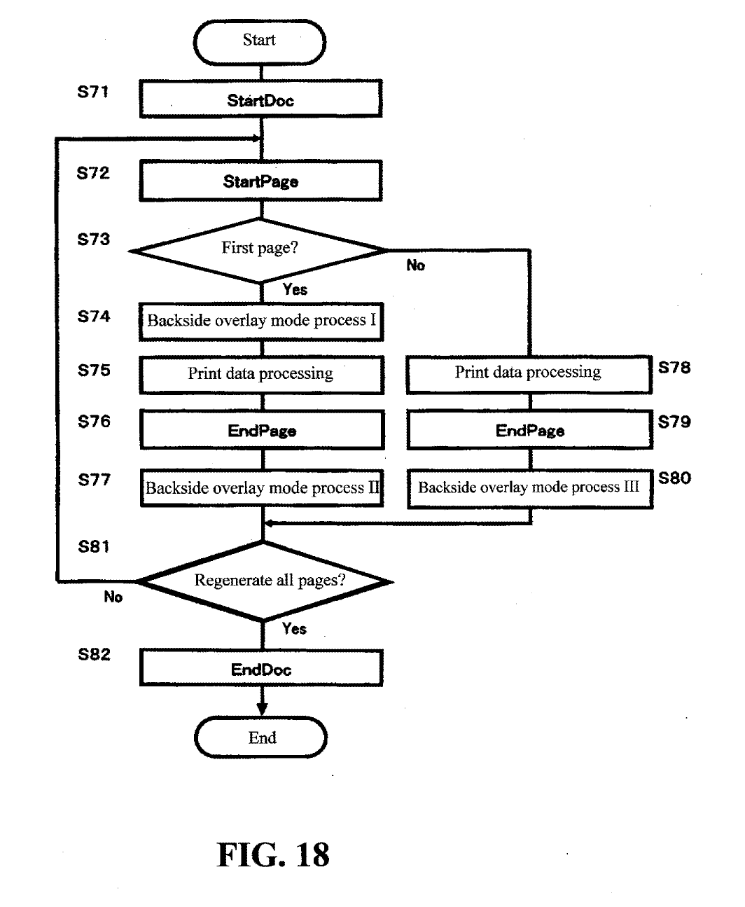

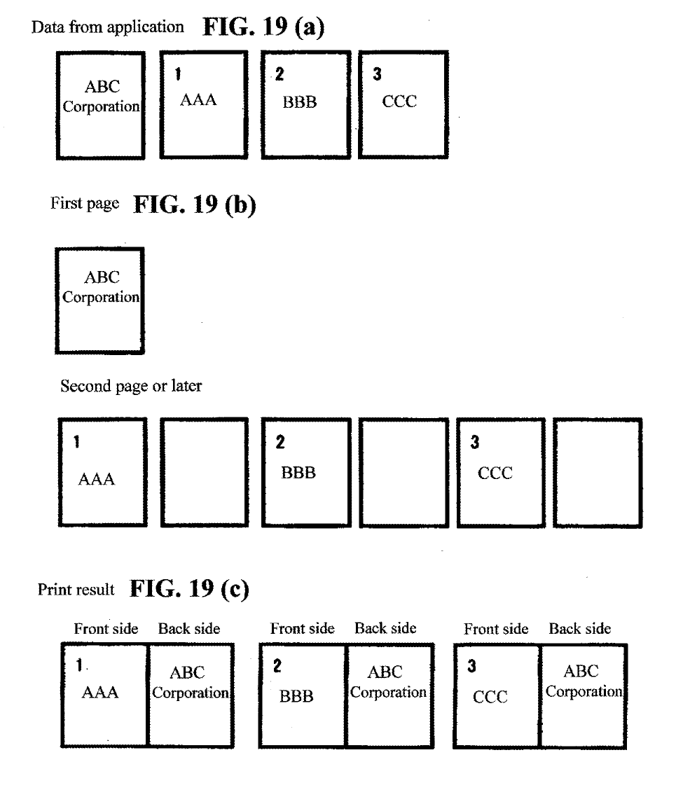

An operation of the print data generating apparatus will be explained next. FIG. 18 is a flow chart showing a process of the backside overlay printing according to the third embodiment of the present invention. FIGS. 19(a) to 19(c) are views showing examples of the data and a printed result according to the third embodiment of the present invention.

FIG. 19(a) is a view showing the data created with the application 5. In the embodiment, contents to be printed on the backside in common are created on the first page; contents to be printed on the front side of the first page are created on the second page; contents to be printed on the front side of the second page are created on the third page; and contents to be printed on the front side of the third page are created on the fourth page.

FIG. 19(b) is a view showing a result in which the printer driver 3 creates the form data to be printed on the backside on the first page and non-standard contents on the second and subsequent pages with blank pages in between, and converts them to PDL. FIG. 19(c) is a view showing a result printed with the printer 2.

First, the operator uses the application 5 to create the form data to be printed on the backside in common on the first page, and the non-standard contents on the second and subsequent pages.

In step S71, when the printing is started, the printer driver 3 calls for “StartDoc” from GDI (not shown), so that the print job is started. In step S72, “StartPage” is called to start the page processing. In step S73, it is determined whether the page to be processed is the first page. In step S74, when it is determined that the page to be processed is the first page, it is determined that the backside overlay mode is set, and a backside overlay mode process I is performed for adding a macro ID number assigning command and a macro definition starting command.

In Step S75, the GDI graphic command is converted to PDL as the process of the print data created with the application 5. In step S76, “EndPage” is called. In step S77, a backside overlay mode process II is performed for adding a macro definition ending command, so that the data of the first page are registered to the printer 2 to create the form data for the backside.

In step S78, when it is determined that the page to be processed is the second and subsequent pages in step S73, the GDI graphic command is converted to PDL as the process of the print data created with the application 5. In step S79, “EndPage” is called. In step S80, a backside overlay mode process III is performed for adding a command to set the backside printing for printing the backside in the duplex printing; a command for calling the macro ID used in the backside overlay mode process I used in step S74; and a page flip command.

In step S81, it is determined whether all pages are processed. In step S82, “EndDoc” is called, thereby completing the process. Through the process of the printer driver 3, the data shown in FIG. 19(b) is created. When the data created with the printer driver 3 is sent to the printer 2, the print result shown in FIG. 19(c) is obtained.

In the third embodiment, through the backside overlay printing, the non-standard contents are printed on the front side, and the form data are printed on the backside. The invention is not limited thereto. When the page flip command is added before each of the page with the non-standard contents, it is possible to print the form data on the front side and the non-standard data on the backside.

When the operator wants to print the form data on a specific page, for example, the third page, the page flip command is added the data of a page before the specific page, in this case, after the second page. Accordingly, it is possible to print the form data on the specific page.

In the third embodiment, the first page created with the application 5 becomes the form data. It is possible to register print contents of an arbitrary page as the form page, so that the form data is printed on the backside or a specific page.

As described above, in the print data generating apparatus according to the third embodiment, the data of the first page created with the application 5 are registered to the printer 2 as the form data. The duplex printing mode is set with the printer driver 3. The data of the first page, i.e., the form data, are used relative to the data of the second and subsequent pages for printing the backside. Accordingly, it is not necessary to register the form to the printer 2 in advance. Further, it is possible to increase the form registration at every printing.

The disclosure of Japanese Patent Application No. 2005-285176, filed on Sep. 29, 2005, is incorporated in the application.

While the invention has been explained with reference to the specific embodiments of the invention, the explanation is illustrative and the invention is limited only by the appended claims.

What is claimed is:

1. A print data generating apparatus, comprising:
a receiving unit for receiving first print data formed of a plurality of page data;
a print order editing unit for generating second print data in which form data of the first print data is arranged on a specific page and data other than the form data of the first print data are arranged sequentially on pages other than the specific page; and
an outputting unit for outputting the second print data to a printing device.

2. The print data generating apparatus according to claim 1, wherein said print order editing unit is configured to generate the second print data in which the form data of the first print data is arranged on an even page.

3. The print data generating apparatus according to claim 1, wherein said print order editing unit is configured to generate the second print data in which the form data of the first print data is arranged on the specific page arbitrarily specified.

4. The print data generating apparatus according to claim 1, further comprising a data determining unit for determining a print setting mode of the first data so that the print order editing unit generates the second print data according to the print setting mode.

5. The print data generating apparatus according to claim 1, further comprising a setting unit for setting a print setting mode of the first print data.

6. The print data generating apparatus according to claim 4, further comprising a setting unit for setting the print setting mode of the first print data.

7. The print data generating apparatus according to claim 1, wherein said print order editing unit is configured to generate the second print data in which the form data of the first print data is arranged on a front page as the specific page.

8. The print data generating apparatus according to claim 7, wherein said print order editing unit is configured to generate the second print data in which the data other than the form data of the first print data and a blank page are alternately arranged on the pages other than the specific page.

9. A printing system, comprising:
a print data generating apparatus; and
a printing device connected to the print data generating apparatus to be capable of communicating with each other,
wherein said print data generating apparatus includes:
a receiving unit for receiving first print data formed of a plurality of page data;
a print order editing unit for generating second print data in which form data of the first print data is arranged on a specific page and data other than the form data of the first print data are arranged sequentially on pages other than the specific page; and
an outputting unit for outputting the second print data to the printing device, and
said printing device includes a printing unit for forming an image on a sheet according to the second print data.

10. The printing system according to claim 9, wherein said print order editing unit is configured to generate the second print data in which the form data of the first print data is arranged on a front page as the specific page.

11. The printing system according to claim 10, wherein said print order editing unit is configured to generate the second print data in which the data other than the form data of the first print data and a blank page are alternately arranged on the pages other than the specific page.

12. The printing system according to claim 11, wherein said printing device is configured to register the form data arranged on the first page.

13. A method of generating print data, comprising the steps of:
receiving first print data formed of a plurality of page data;
generating second print data in which form data of the first print data is arranged on a specific page and data other than the form data of the first print data are arranged sequentially on pages other than the specific page; and
outputting the second print data to a printing device.
